(19) United States
(12) Patent Application Publication
(10) Pub. No.: US 2026/0092654 A1
(43) Pub. Date: Apr. 2, 2026

(54) VALVE

(71) Applicant: ILLINOIS TOOL WORKS INC., Glenview, IL (US)

(72) Inventors: Carlo GAMBINO, Bra (IT); Laurent HUET, Meru (FR); Emmanuel OUINE, Weinbourg (FR)

(21) Appl. No.: 19/344,145

(22) Filed: Sep. 29, 2025

(30) Foreign Application Priority Data
Sep. 30, 2024 (EP) 24203572.3
Nov. 19, 2024 (EP) 24213962.4
Feb. 11, 2025 (EP) 25157224.4
Sep. 11, 2025 (DE) 102025136748.5

(51) Int. Cl. F16K 31/08; F16K 31/06

(52) U.S. Cl. CPC F16K 31/084; F16K 31/0655

(57) ABSTRACT

A valve, suitable for releasing a pressure build up from a vessel, the valve comprising an electric switch operable through variations in a local magnetic field; magnet proximate the electric switch; wherein operation of the valve changes the position of the magnet relative to the electric switch, and therefore varying the local magnetic field.

### RELATED APPLICATIONS

The present application claims the benefit of European (EP) patent application Ser. No. 24/203,572.3, filed Sep. 30, 2024, to European (EP) patent application Ser. No. 24/213,962.4, filed Nov. 19, 2024, to European (EP) patent application Ser. No. 25/157,224.4, filed Feb. 11, 2025, and to German (DE) Patent Application No. 10 2025 136 748.5, filed Sep. 11, 2025” The entireties of European (EP) patent application Ser. No. 24/203,572.3, European (EP) patent application Ser. No. 24/213,962.4, European (EP) patent application Ser. No. 25/157,224.4, and German (DE) Patent Application No. 10 2025 136 748.5 are expressly incorporated herein by reference.

### TECHNICAL FIELD

The present disclosure relates to pressure-relief valves for battery systems, particularly those used in electric vehicle battery packs. More specifically, this disclosure concerns a valve that provides both mechanical pressure relief and electronic feedback to a vehicle's control system when internal battery pressure exceeds a defined threshold.

### BACKGROUND

In recent years, electric vehicles have become increasingly prevalent, requiring energy-dense battery packs capable of sustained performance under a variety of operating conditions. During charging, discharging, or under fault conditions such as internal short circuits or thermal runaway, these battery cells may generate gases. This gas accumulation leads to increased internal pressure within the battery pack enclosure. If the pressure is not adequately managed, it can result in case deformation, rupture, fire, or explosion.

To address this, current battery systems often include vent valves designed to release internal pressure once it reaches a critical threshold. Common solutions include spring-loaded or burst-disk type valves, which open at a pre-calibrated pressure to allow rapid gas release. Some modern designs integrate porous membranes or breathing vents to allow for gradual pressure equalization and moisture management during normal operation. These components are intended to prevent excessive build-up of pressure, maintain enclosure integrity, and manage ingress protection.

However, existing valve technologies present several limitations. Many vent valves function as passive mechanical devices that do not provide any indication when activation has occurred. This absence of feedback delays detection of abnormal operating conditions such as thermal events, potentially compromising the response time of the vehicle's safety systems. Furthermore, valves that rely solely on mechanical actuation can be vulnerable to clogging, sealing failure, or inconsistent performance due to material fatigue, contamination, or variation in assembly tolerances.

While some advanced venting systems have attempted to incorporate dual-stage operation or compact footprints, integration with vehicle electronics remains limited. Pressure events within the battery pack may go unnoticed unless additional pressure sensors or diagnostic hardware are separately installed. This increases the complexity of the system architecture and introduces additional failure modes or maintenance requirements.

There is therefore a need for a venting solution that not only responds reliably to excess internal pressure but also provides a real-time signal to the vehicle's electronic control unit. Such a solution should ideally combine pressure-activated mechanical movement with an integrated sensing mechanism, such as a magnetically actuated electric switch. This enables the system to detect valve operation and transmit a signal when pressure exceeds a defined threshold. The valve should be compact, manufacturable, and capable of returning to its sealed position once the pressure subsides, restoring the system to its normal operating state.

The present disclosure addresses these deficiencies by providing a valve capable of venting battery pressure when required, while simultaneously triggering a sensor that communicates the event to the vehicle's control system. This ensures improved system diagnostics, early warning capabilities, and enhanced overall safety of the battery pack without compromising the mechanical simplicity or compactness of the valve design.

### SUMMARY

In accordance with the present disclosure, there is provided a valve according to the appended claims.

According to an aspect of the present disclosure, there is provided a valve, suitable for releasing a pressure build up from a vessel, the valve comprising
an electric switch operable through variations in a local magnetic field;
a magnet proximate the electric switch;
wherein operation of the valve changes the position of the magnet relative to the electric switch, and therefore varying the local magnetic field.

Advantageously, this configuration enables the valve not only to perform a mechanical pressure relief function but also to provide an electronic indication of valve actuation. By integrating a magnet and a switch sensitive to magnetic field variation, the system permits real-time monitoring of overpressure events within the vessel, such as a battery pack. This eliminates the need for separate pressure sensors or complex diagnostic circuitry. The change in relative position between the magnet and the electric switch as the valve moves allows the switch to trigger a signal to an electronic control unit or monitoring system, thereby improving the responsiveness and safety of the overall system. Furthermore, because the sensing mechanism is based on non-contact magnetic actuation, it is less prone to mechanical wear, contamination, or sealing issues compared to conventional pressure sensors or contact-based switches. This results in a robust, low-maintenance solution for monitoring internal pressure conditions while maintaining compactness and case of integration with existing valve assemblies.

In an embodiment, the valve is configured to move to an open position once a threshold pressure is reached. Advantageously, Advantageously, this allows the valve to operate passively and autonomously in response to pressure conditions within the vessel, such as a battery enclosure. By calibrating the valve to open at a predetermined pressure threshold, the system ensures timely venting of gases or fluids during abnormal or hazardous events, such as thermal runaway, thereby reducing the risk of structural failure, leakage, or explosion. This pressure-responsive actuation also enables precise control over when venting occurs, minimizing unnecessary or premature openings, and helping to maintain environmental sealing under normal operating conditions. The threshold-based movement contributes to the overall safety and reliability of the vessel, while simplifying system architecture by avoiding the need for complex active control components.

In another embodiment, the valve further comprises a body attachable to an opening of a vessel. In yet another embodiment, the body comprises a fluid pathway to allow a fluid to cross a vessel wall via the valve. Advantageously, providing a body that is attachable to a vessel opening ensures secure and stable integration of the valve into various enclosure designs, such as battery housings or pressure vessels, without the need for extensive modification or custom fittings. The inclusion of a defined fluid pathway through the body allows controlled and directed movement of gases or liquids from inside the vessel to the external environment when pressure conditions require it. This supports both degassing under overpressure conditions and breathing during normal operation, depending on the configuration of the valve. Together, the attachable body and internal fluid pathway enhance the valve's compatibility, ease of installation, and functional reliability across a range of system architectures.

In an embodiment, the valve further comprises at least one gate. In another embodiment, the gate is arranged to move within the fluid pathway between an open position and a closed position. In yet another embodiment, the movement of the gate changes the position of the magnet relative to the switch. Advantageously, incorporating a movable gate within the fluid pathway enables precise control over the opening and closing of the valve in response to internal pressure conditions. The gate serves as a mechanical barrier that regulates the flow of gases or fluids, enhancing the valve's ability to maintain a sealed environment under normal conditions while providing rapid venting when required. By linking the movement of the gate to the displacement of a magnet, the system ensures that actuation of the gate simultaneously triggers a measurable change in the magnetic field detected by the switch. This integration allows a single mechanical motion to perform dual functions: relieving pressure and transmitting a diagnostic signal. Such coordination simplifies the overall design, reduces component count, and improves reliability by minimizing the number of moving parts required to achieve both fluid control and electronic feedback. The configuration also allows for compact packaging, making it especially suitable for space-constrained applications such as battery enclosures in electric vehicles.

In an embodiment, the valve further comprises a fluid-permeable membrane. Advantageously, the inclusion of a fluid-permeable membrane allows for continuous pressure equalization between the interior of the battery pack enclosure and the external environment under normal operating conditions, without requiring the valve to open fully. This “breathing” functionality prevents the buildup of minor pressure differentials caused by thermal expansion, altitude changes, or normal charging and discharging cycles, thereby preserving the structural integrity of the battery housing and reducing mechanical stress on seals and enclosure interfaces. The membrane can be configured to block the ingress of external contaminants such as water, dust, or electrolyte vapors, maintaining the internal environment while allowing safe gas exchange. By enabling passive venting of low-pressure fluctuations, the membrane reduces the frequency of full valve actuations, enhancing the durability and long-term reliability of the battery system.

In an embodiment, the valve further comprises biasing means to urge the valve into either an open position or a closed position. In another embodiment, the biasing means urges the at least one gate into either an open position or a closed position. Advantageously, the use of biasing means ensures that the valve or gate reliably returns to its default position after an actuation event, maintaining consistent operational behavior and sealing performance. When configured to urge the valve or gate into a closed position, the biasing means helps preserve the sealed state of the battery pack enclosure under normal pressure conditions, preventing unintended venting and protecting internal components. Conversely, when configured to urge the valve or gate into an open position, it can support rapid and complete venting once the actuation threshold is reached. The biasing mechanism also reduces the likelihood of mechanical sticking or incomplete resealing after venting, thereby enhancing the reliability of the valve in repeated pressure cycles. This contributes to the overall safety and stability of the battery system, particularly in demanding automotive environments where vibration, temperature fluctuations, and mechanical shock are common.

In an embodiment, when comprising a gate, the magnet is arranged to assist movement of, and/or at least temporarily maintain a position of, the gate. Advantageously, the use of the magnet to assist or stabilize the movement of the gate enhances the responsiveness and reliability of the valve under dynamic pressure conditions. By contributing additional magnetic force to the actuation or retention of the gate, the magnet can help ensure that the gate moves promptly when required, such as during a rapid pressure rise, and remains in the open position long enough to allow sufficient venting. This can be especially beneficial in scenarios involving transient pressure spikes, where a purely mechanical biasing element might otherwise allow the gate to close prematurely. Conversely, magnetic attraction can also help retain the gate in the closed position under normal conditions, improving sealing integrity. This dual functionality enables more precise control over the valve's behavior without increasing mechanical complexity, and supports a more predictable and stable response across a range of operating pressures. As a result, both venting efficiency and sealing performance are improved, which is critical for the safety and longevity of battery systems in electric vehicles.

In an embodiment, the electric switch is arranged to be clippably connected to the valve. Advantageously, a clippable connection allows the electric switch to be easily installed, removed, or replaced without requiring disassembly of the entire valve or battery housing. This modular approach simplifies manufacturing, inspection, and maintenance processes, reducing assembly time and enabling efficient integration into various system architectures. It also allows for flexibility in selecting or upgrading the switch component independently of the valve body, accommodating different sensing specifications or communication protocols as needed. Additionally, a secure Clip mechanism ensures consistent positioning of the switch relative to the magnet, maintaining reliable signal activation during valve operation. The non-permanent but stable connection further enhances design adaptability while preserving the functional integrity of the valve and sensor system.

In an embodiment, the valve comprises a housing arranged to receive the electric switch. In another embodiment, the housing comprises a door. In yet another embodiment, the door is a hinged door. Advantageously, the inclusion of a dedicated housing for the electric switch provides physical protection and precise positioning of the switch within the valve assembly, ensuring reliable operation in harsh environments such as those encountered in automotive applications. The housing isolates the switch from dust, moisture, vibration, and mechanical impacts, preserving its sensitivity and extending its operational lifespan. When the housing includes a door, particularly a hinged door, it enables easy access to the switch for installation, inspection, testing, or replacement, without disturbing the rest of the valve or enclosure. A hinged design allows the door to remain attached during servicing, reducing the risk of misplacement and simplifying handling. This approach enhances the maintainability and modularity of the valve system while ensuring the switch remains securely enclosed during normal operation. Overall, the housing and door combination improves reliability, serviceability, and integration flexibility within electric vehicle battery systems.

### BRIEF DESCRIPTION OF THE DRAWINGS

Embodiments of the disclosure are now described, by way of example only, hereinafter with reference to the accompanying drawings.

FIG. 1A illustrates a valve in a closed position.

FIG. 1B illustrates the valve of FIG. 1A in an open position.

FIG. 1C illustrates the valve of FIG. 1A in a return to a closed position.

FIG. 2 illustrates a valve with the various elements labelled.

FIG. 3A illustrates a further valve in a closed position.

FIG. 3B illustrates the valve of FIG. 3A in an open position.

FIG. 4 illustrates the valve of FIG. 3A in the closed position with the various elements labelled.

FIGS. 5A-5D illustrate an alternative valve.

FIGS. 6A-6D illustrate an alternative valve.

FIGS. 7A-7D illustrate an alternative valve.

FIGS. 8A-8D illustrate an alternative valve.

FIGS. 9A-9D illustrate an alternative valve.

FIGS. 10A-10D illustrate an alternative valve.

FIGS. 11A-11E illustrate an alternative valve.

FIG. 12A illustrates a further valve in a closed position.

FIG. 12B illustrates the valve of FIG. 12A in an open position.

FIG. 13A illustrates a body of a valve in a first variation.

FIG. 13B illustrates a body of a valve in a second variation.

FIG. 13C illustrates a body of a valve in a third variation.

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outer’ and ‘outwardly’ refer to directions toward and away from, respectively, a designated centerline or a geometric center of an element being described (e.g. central axis), the particular meaning being readily apparent from the context of the description.

Further, as used herein, the terms ‘connected’, ‘attached’, ‘coupled’ and ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second” and “third” etc. merely indicate that different instances of like objects are being referred to and are not intended to imply that the objects so described must be in a given sequence, either temporally, spatially, in ranking or in any other manner.

Like reference numerals are used to depict like features throughout.

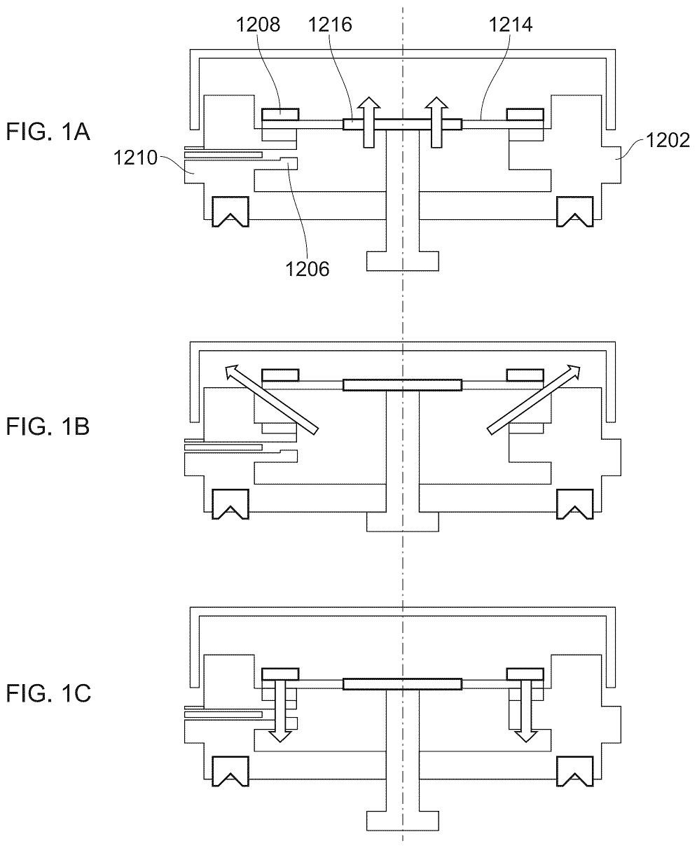

A valve 1202 is shown in FIG. 1A in a closed position, in FIG. 1B in an open position, and in FIG. 1C in a closed position, after returning from the open position. The valve 1202 has a body 1210 and a valve component with cooperating magnetic means for closing the valve component when the pressure falls below the force of attraction of the magnetic means and for opening the valve component when the pressure is above said force of attraction (thereby providing a degassing function). The valve component may be configured to slide with respect to the body between open and closed positions. The valve component may have a stop for blocking further sliding when the valve component reaches the open position. The valve component may be made of plastic or a thermoplastic elastomer (TPE). The valve component may have a porous or other fluid permeable membrane 1216 (thereby providing a venting function). The magnetic means may be a permanent magnet 1208 such as a ring magnet or a ferromagnetic ring. The body may comprise a reed switch or any other suitable electric switch 1206 that is configured to change state when the distance between the magnetic means reaches a certain value and sends a signal to the electronic control unit (ECU) that a thermal runaway has occurred. The body may comprise a sealing element made of TPE or rubber to ensure waterproofness.

Closed condition (FIG. 1A): the attraction between the magnetic ring and the ferromagnetic material keeps the valve closed with the TPE or elastomeric sliding element scaling against the valve body and ensuring waterproofness. Air can flow through the optional porous membrane.

The normally closed (NC) reed switch is keeping the circuit open thanks to the proximity of the magnetic ring.

Open condition (FIG. 1B): the pressure inside the enclosed system, such as a battery pack, surpasses a certain threshold sufficient to overpower the magnetic attraction, lifting the sliding part and allowing the valve to open and release internal gases. This rapid pressure relief prevents further escalation of thermal events or enclosure rupture. s. The reed switch becomes closed as the distance from the magnet increases and the magnetic field strength at the switch falls below its activation threshold, sending a signal to the ECU that a thermal runaway or other critical pressure event has occurred.

When the pressure decreases, the magnetic attraction brings back the valve to a closed position and the reed switch returns to the open state (FIG. 1C, see arrows). The system therefore functions with a passive mechanical response and automatic electronic signaling, resetting without the need for manual intervention.

The goal of including the reed switch is to have electronic information when the valve goes beyond a certain outgassing threshold (state of opening or closing), which means that the battery pack is in the overpressure phase. To enable this, a magnet and reed switch are integrated within a compact (flat) valve configuration. This reed switch transmits the loss or passage of information depending on whether it is normally open or normally closed. The signal can be used by the control system for early warning, automated shutdown, or diagnostic logging.

The reed switch is integrated into the valve body, on the inside or outside surface of the body, depending on packaging and signal routing needs. The magnet is integrated into a moving part of the valve, such as a sliding cap or hood. When the valve cover (hood) opens under a certain pressure, at a displacement distance calibrated to the reed switch's sensitivity, the magnet triggers the reed switch and places the switch into an open or closed position as appropriate. This is to be calibrated according to the user's expectations and the performance of the reed switch, including parameters such as actuation distance, hysteresis, and magnetic field strength. The reed switch may change position when a predetermined threshold (i.e. degree of valve opening) is reached.

The reed switch may be placed internally to the valve or externally to the valve housing. The reed switch may be integrally formed or separately formed with the valve. Where formed separately, the reed switch may be provided as a snap fit with the valve to allow easy manufacture and/or replacement without removal or replacement of the valve itself.

Ideally, switch placement does not negatively impact the overall dimensions of the valve (i.e. maintain the size of the valve without a reed switch), nor should the switch affect the function of the valve (i.e. impede or effect fluid flow through the valve).

The reed switch may be designed to detect the proximity of a metal and/or a magnet. The output of the reed switch may be via an electrically conductive wire or via wireless communication using, for example, low-power RF transmitters integrated with the switch casing.

The reed switch, wherever it is placed, should preferably be protected from the surrounding environment and from ingress of contaminants or exposure to conditions that would adversely affect the operation of the reed switch (e.g. temperature and humidity, vibration, or contaminants). This may be achieved through encapsulation, gaskets, or dedicated housings designed to meet relevant ingress protection (IP) standards.

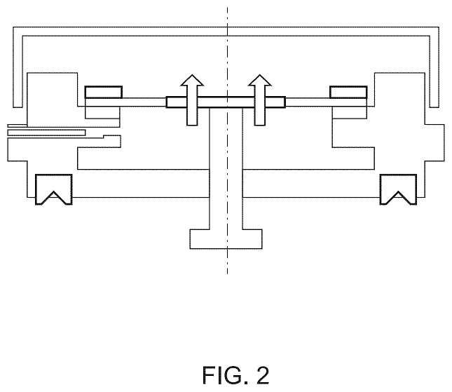

FIG. 2 shows the valve of FIG. 1A in the closed position and with the elements labelled. The drawing includes both required and optional elements, with optional features specifically indicated to reflect configuration-dependent implementations. This view provides a reference for component identification and supports the understanding of how individual parts interact in the sealed (closed) state.

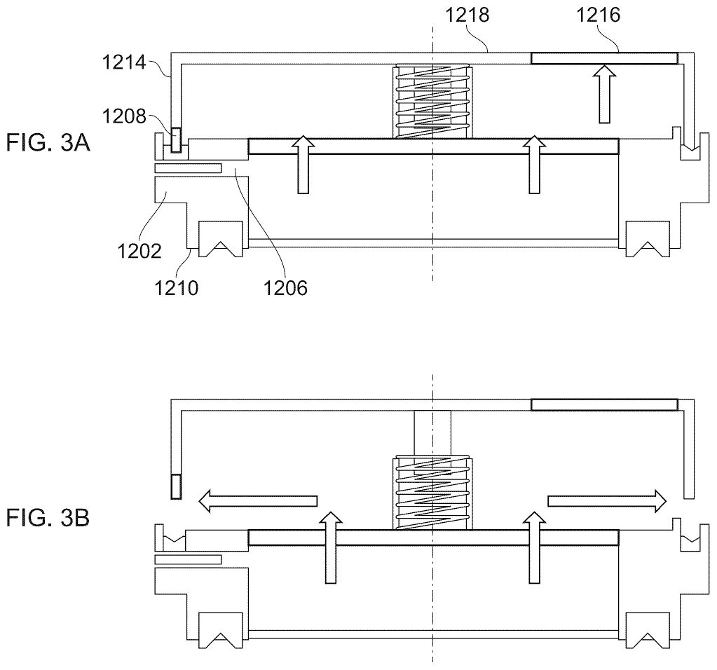

FIG. 3 shows a similar valve 1202 to that of FIGS. 1A-IC and FIG. 2. The valve differs in the provision of a spring, or other suitable biasing means 1218, which acts on the sliding component to control its position. The spring or other suitable biasing means 1218 biases the valve towards either the open or closed position (depending on the spring used) and ensures the valve does not become stuck in a given position, while ensuring a prompt return to an alternative position. FIG. 3A shows the valve in a closed position. FIG. 3B shows the valve in an open position. The valve operates in a similar fashion to that shown in FIGS. 1A-1C, with the main difference being the use of an active biasing element to assist the return movement rather than relying solely on magnetic attraction. This provides additional design flexibility for tuning valve behavior under different pressure scenarios.

FIG. 4 shows the valve of FIG. 3A in the closed position and with the elements labelled. Both essential and optional components are identified, with optional features marked to indicate their applicability in specific configurations or variants. This detailed labelling aids in understanding the internal arrangement and operation of the valve in its sealed state.

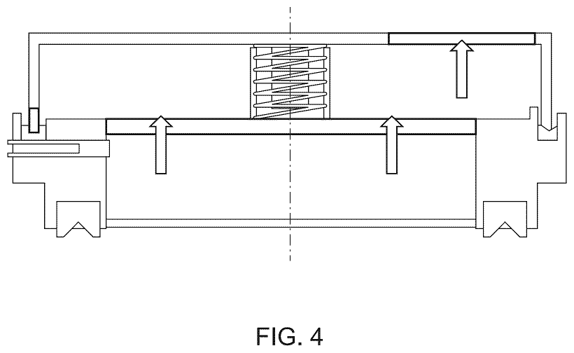

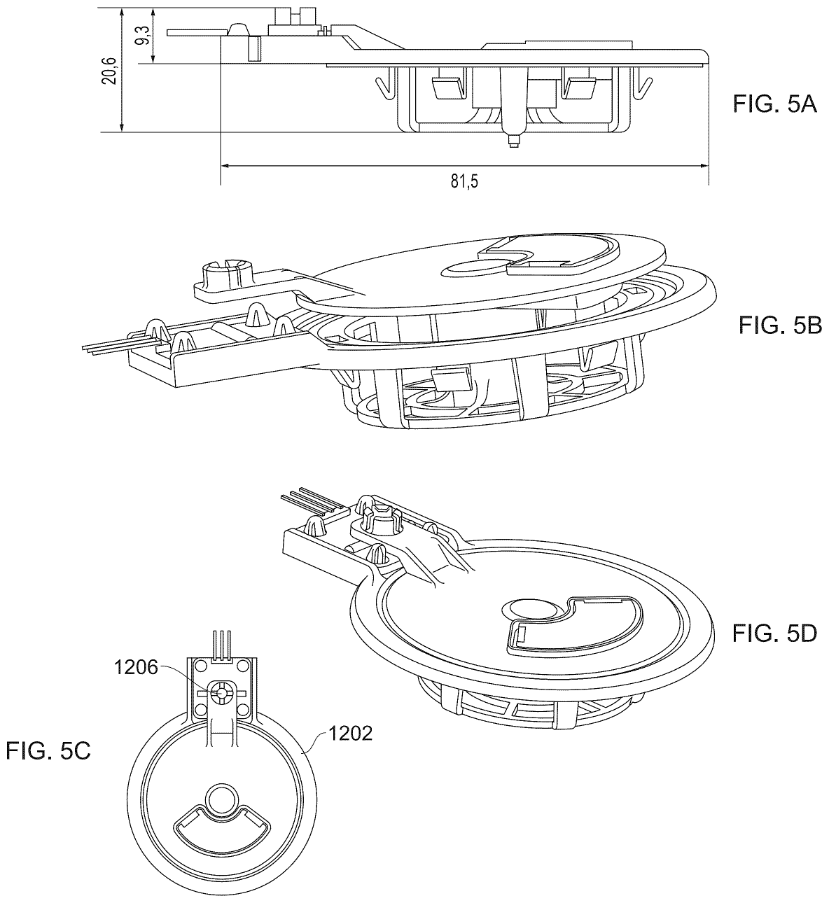

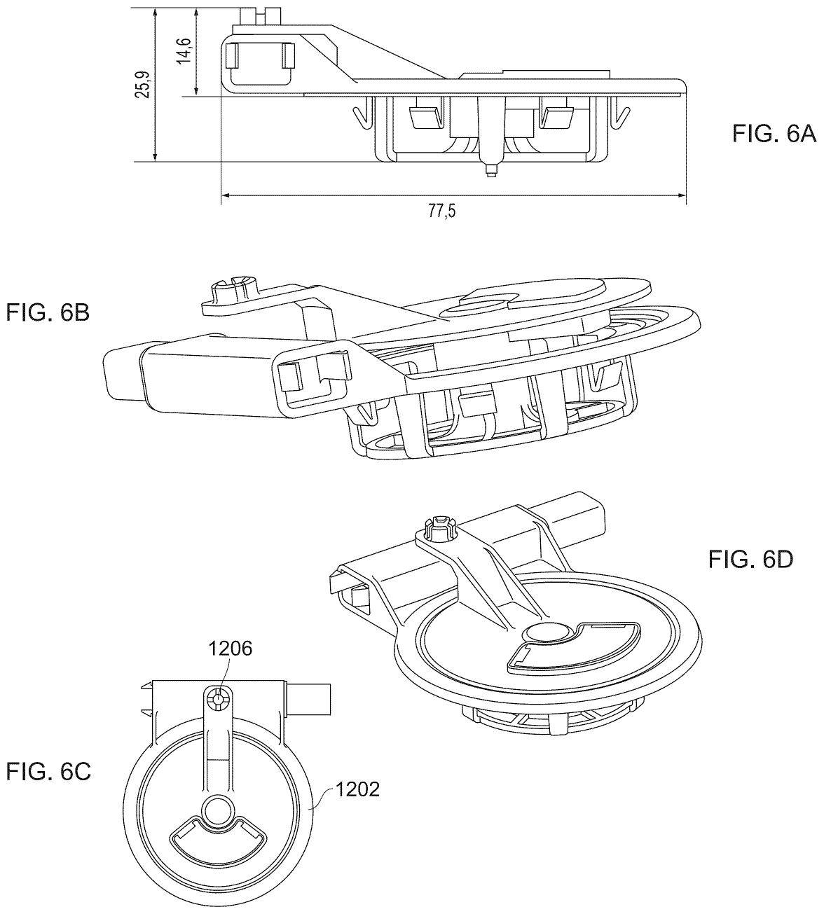

A variety of electric switches 1206 are available to select from and the size, shape, and configuration of the selected switch may provide advantageous characteristics to the valve 1202. FIGS. 5A-5D and FIGS. 6A-6D show valves 1202 having electric switches 1206 (e.g. a reed switch) that are relatively flat and therefore reduce the profile of the valve 1202.

The electric switch 1206 of FIGS. 6A-6D is chip protected for enhanced durability and easy to fasten to the valve 1202 via a clip-in mount and therefore can be quickly and securely connected to the vehicle.

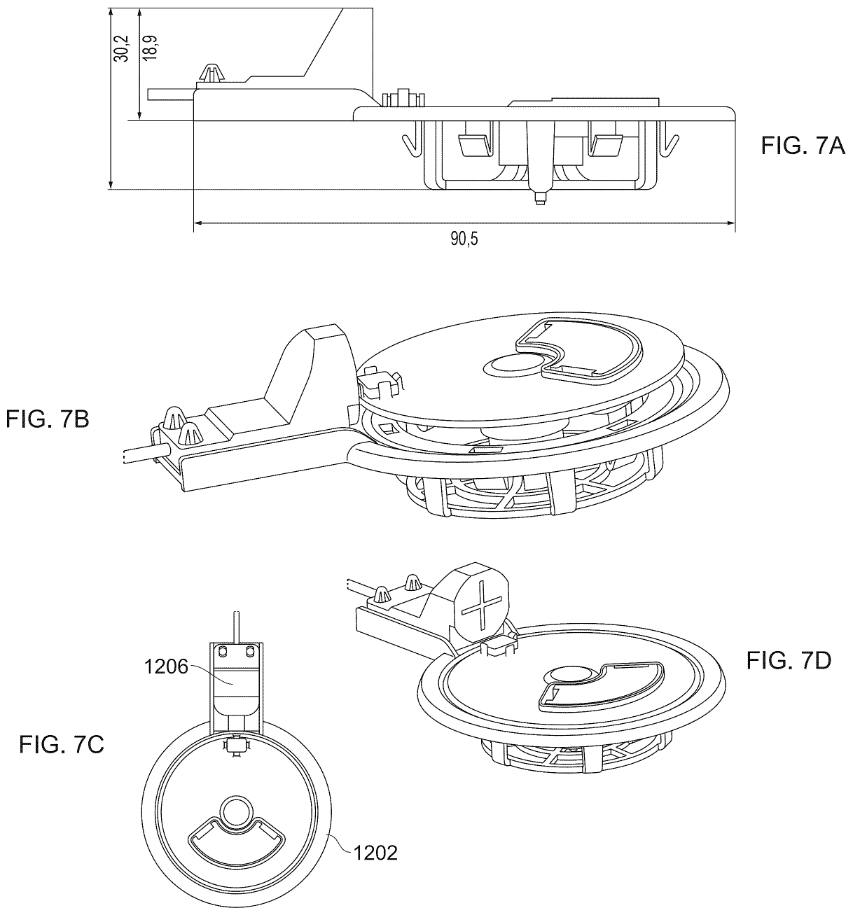

The electric switch 1206 of FIG. 7A-7D has an angled profile, and is designed to pick up only magnetized materials and not non-magnetic materials (e.g. plain ferrous metals without residual magnetism.

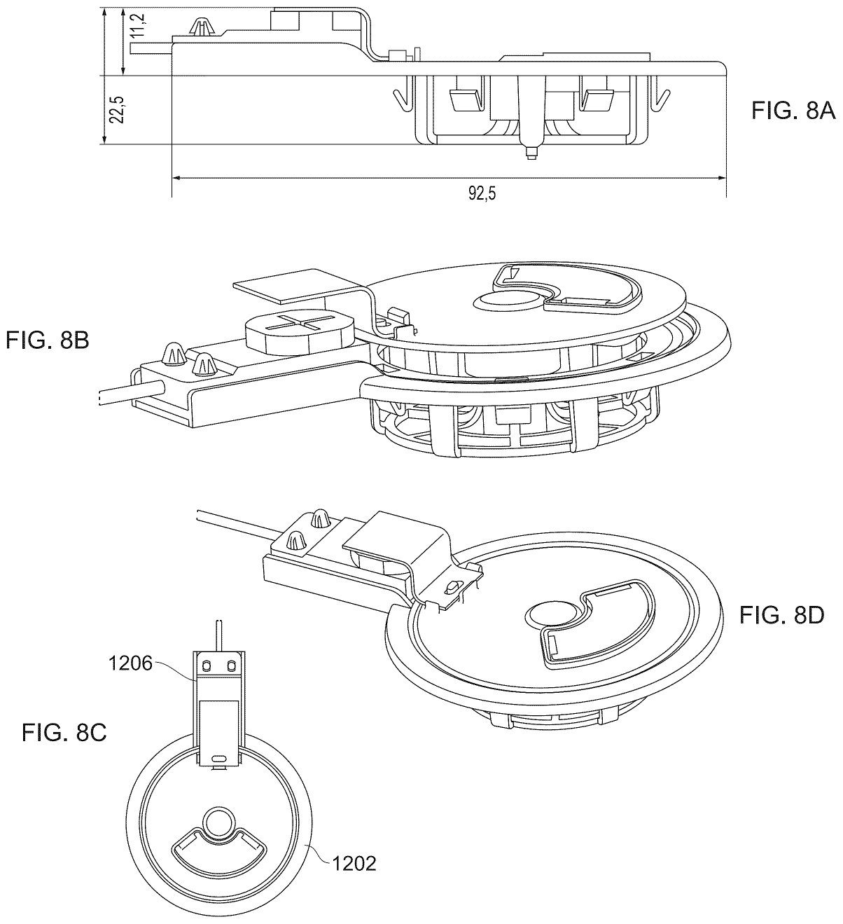

The electric switch 1206 of FIG. 8A-8D has a flat profile and is designed to pick up only magnetized materials while rejecting signals from surrounding conductive but non-magnetic components.

In this configuration shown in FIGS. 8A-8D, the electric switch 1206 provides a space-saving solution, as the magnet can be positioned above the valve body 1210 rather than enclosed within it. Certain switch types may support flexible or adaptive connectivity options, including pluggable or wireless interfaces, depending on system requirements.

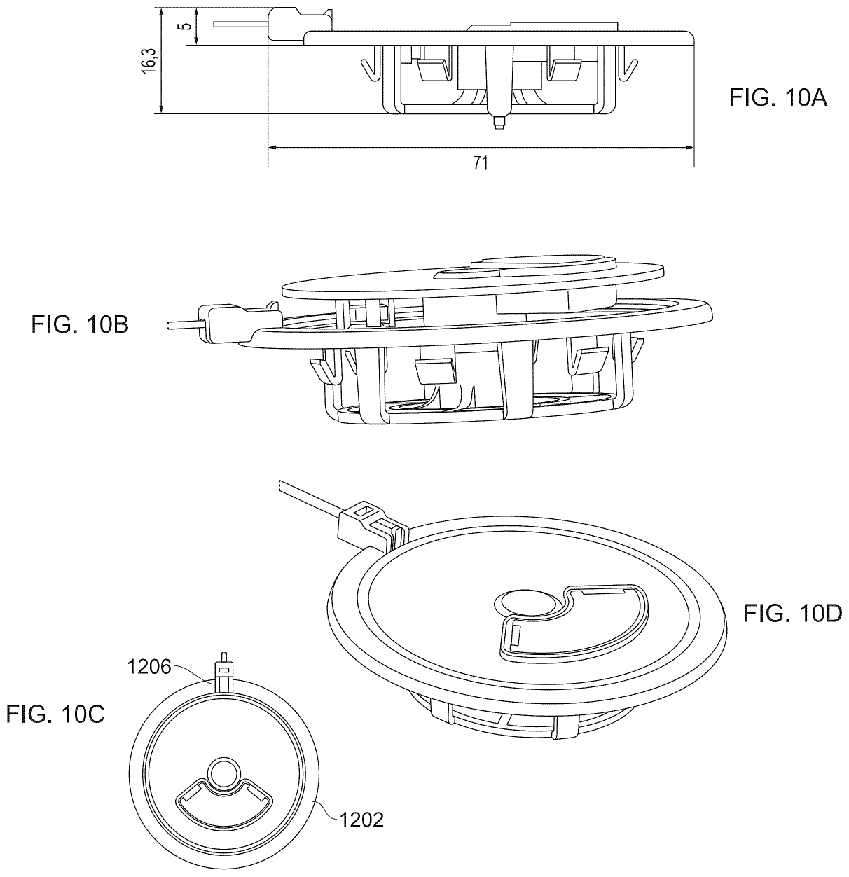

The electric switch 1206 of FIGS. 10A-10D allows the magnet to be placed below the valve body 1210 providing an alternative space-saving solution.

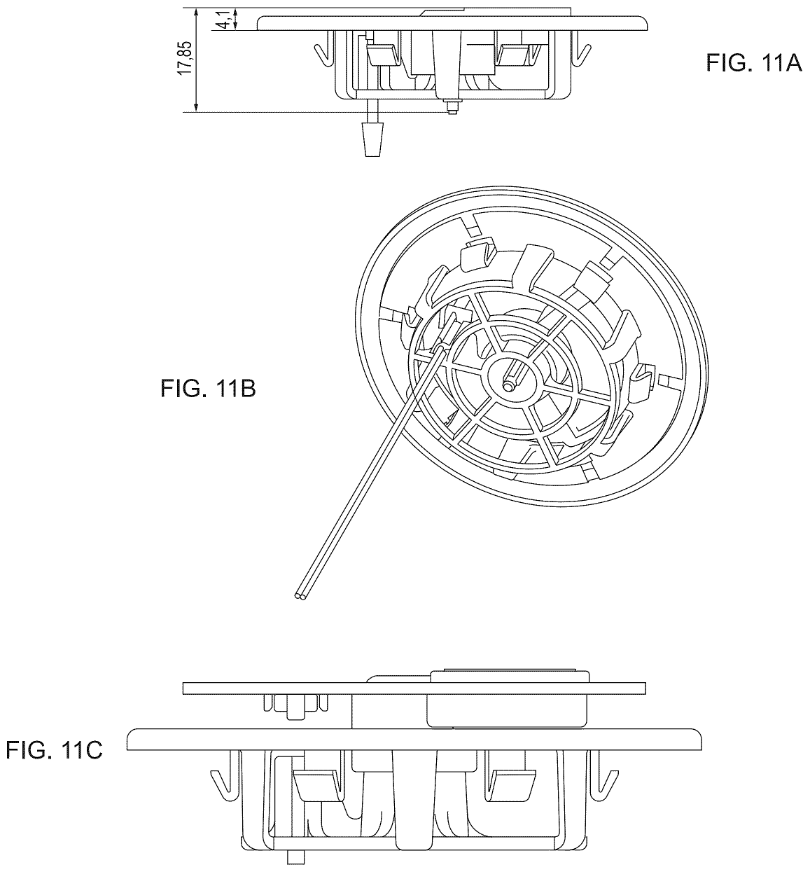

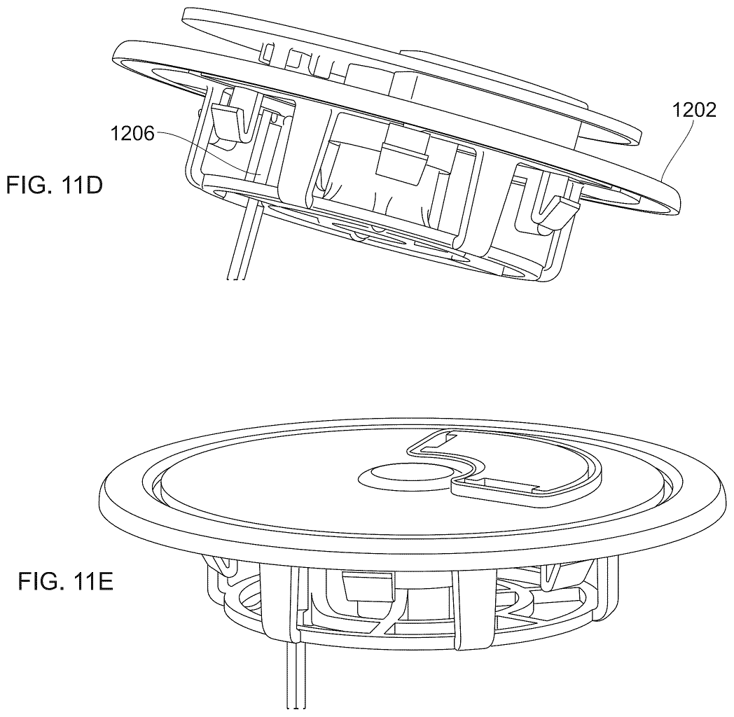

The electric switch 1206 of FIG. 11A-11E provides an alternative space-saving solution due to its small size and the fact that it is insertable into the body 1210 from below (i.e. Within the vessel 1204). This design enables integration without increasing the external footprint of the valve.

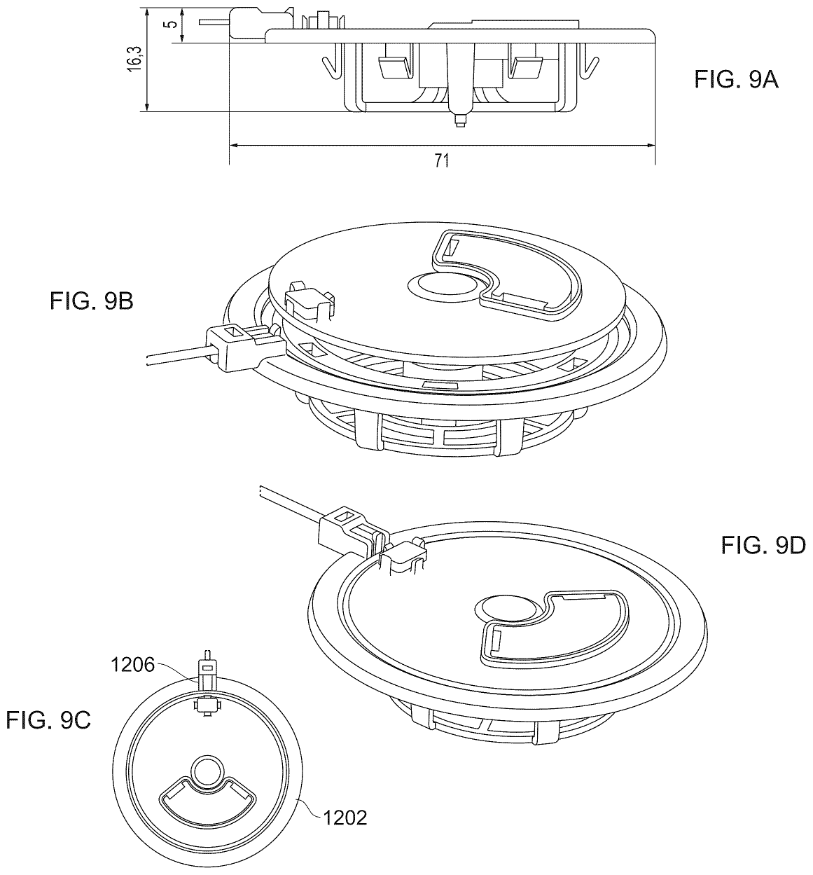

Relative differences in dimensions are provided in the A) image of each of FIG. 5A to FIG. 11E. These dimensional differences are expressed as ratios (e.g., in millimeters) to compare height, width, and depth across configurations. For example, in FIGS. 5A-5D, the valve 1202 may have a depth of 20.6 units relative to a width of 81.5 units, indicating a relatively low-profile design.

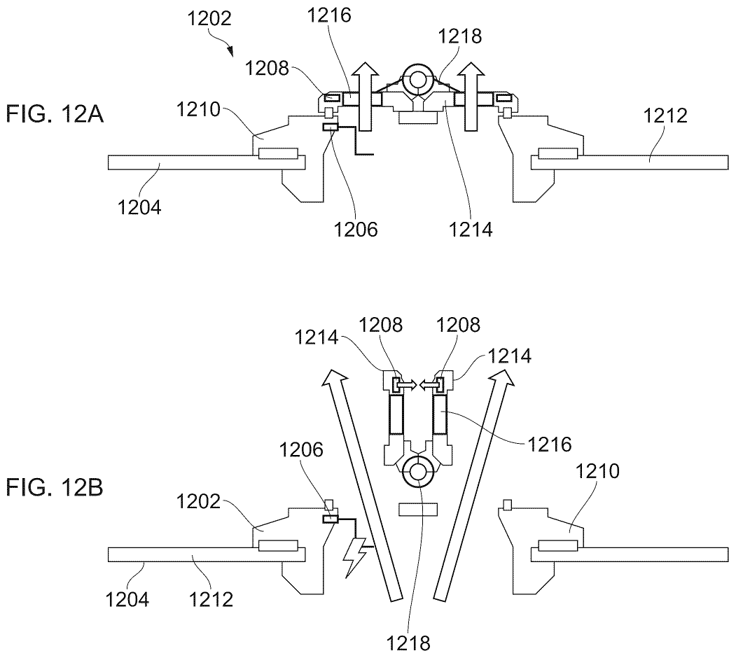

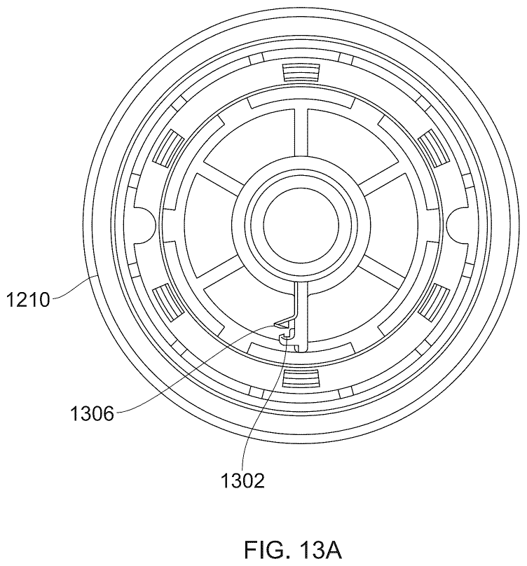

FIG. 12A shows a valve 1202, suitable for releasing a pressure build up from a vessel 1204. The valve 1202 has an electric switch (such as but not limited to, a reed switch). In this context, the switch is configured to be to be operated by the valve 1202, so the switch detects an operational state of the valve 1202). The switch is operable through variations in a local magnetic field.

To provide the variations in the local magnetic field, a magnet is provided proximate to the electric switch. Here, “proximate” refers to a distance at which the magnetic field is sufficient to trigger or deactivate the switch. The effective distance may vary depending on the magnetic strength, switch sensitivity, ambient conditions, and mechanical tolerances.

Operation of the valve 1202 changes the position of the magnet 1208 relative to the electric switch 1206, and therefore varies the local magnetic field. The electric switch 1206 therefore operates in response to the variation in the magnetic field.

The valve can optionally be configured to move to an open position once a threshold pressure is reached.

The valve 1202 may further comprise a body 1210 that is attachable to an opening of a vessel 1204.

The body can optionally comprise a fluid pathway to allow a fluid to cross a vessel wall 1212 via the valve.

The valve can optionally comprise at least one gate 1214 to regulate fluid flow (fluids can be liquids or gases). The gate 1214 may be arranged to move within the fluid pathway between an open position and a closed position, and further optionally, the movement of the gate can change the position of the magnet relative to the switch.

The valve may further comprise a fluid permeable membrane 1216 in addition to the gate 1214 or in place of the gate 1214. The fluid permeable membrane 1216 may permit a predetermined amount of fluid to pass the valve 1202 without operation of the electric switch 1206.

The valve may comprise biasing means 1218 (such as a spring or weight) to urge the valve into either an open position or a closed position. When comprising a gate 1214, the biasing means 1218 can be arranged to urge the at least one gate into either an open position or a closed position.

The magnet can also be arranged to assist movement of, and/or at least temporarily maintain a position of, the gate 1214 to ensure adequate venting and prevent the biasing means 1218 from operating too swiftly.

This disclosure relates to a vent valve 1202 designed for electric vehicle batteries. The valve consists of a body attached to the battery casing, featuring an electric switch (e.g. a reed switch), and movable elements held in place by a biasing means 1218 (e.g. a spring). These elements contain a magnet and a fluid permeable membrane. When the internal battery pressure increases, air can escape through the porous surface. If the pressure surpasses a certain threshold, overcoming the spring's resistance, the movable elements open wider, allowing for more substantial venting. During this process, the magnets move away from the reed switch, causing the magnetic field to weaken at the switch, which closes the circuit and sends an electrical signal to the control unit. The magnets can also aid in opening the valve by adding their force to the venting pressure. Once the pressure normalizes, the spring returns the movable parts to their original position, and the reed switch opens, cutting off the signal to the control unit.

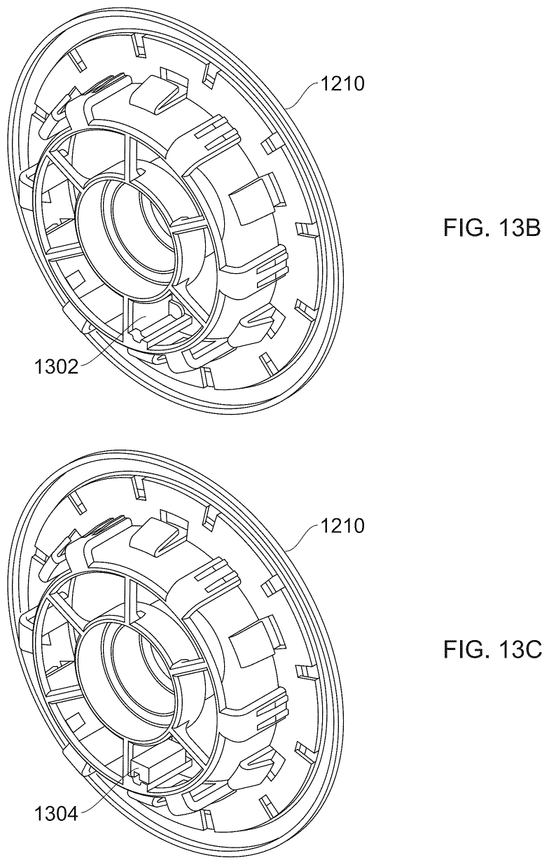

FIGS. 13A-13C show valve bodies 1210 with alternative attachment means for the electric switch 1206. In FIG. 13A, the electric switch (1206) is arranged to be clippably connected (i.e. attached via a clip connection) to the valve 1202. This is provided as a clip 1306 in the figure arranged to grip the electric switch and hold the electric switch in a relative position to the body 1210. Alternatively, the clip may be integrated into the electric switch itself (see FIGS. 6A-6D), with the body 1210 providing a corresponding mounting feature for secure engagement.

Alternatively, or in addition, and as shown in FIG. 13B, the valve may comprise a housing 1302 arranged to receive the electric switch, which may at least partially surround the electric switch 1206 so as to hold the position of the electric switch relative to the body. Further optionally, the housing 1302 can comprise a door 1304 (see FIG. 13C) arranged to close upon the electric switch to retain the electric switch within the housing 1302. The door may be provided with a hinge to allow the door to swing open and shut relative to the housing 1302.

A lock mechanism may be provided to hold the door in either or both (consecutively) in the open or closed position. The lock mechanism may be provided irrespective of the presence of a hinge.

These configurations allow for flexible and modular installation of the electric switch, supporting ease of assembly, maintenance, and replacement across different valve architectures.

It will be appreciated by persons skilled in the art that the above detailed examples have been described by way of example only and not in any limitative sense, and that various alterations and modifications are possible without departing from the scope of the invention as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract or drawings), or to any novel one, or any novel combination, of the steps of any method or process so disclosed.

1. A valve, suitable for releasing a pressure build up from a vessel, the valve comprising:
an electric switch operable through variations in a local magnetic field;
a magnet proximate the electric switch;
wherein operation of the valve changes the position of the magnet relative to the electric switch, and therefore varying the local magnetic field.

2. The valve of claim 1, wherein the valve is configured to move to an open position once a threshold pressure is reached.

3. The valve of claim 1, further comprising a body attachable to an opening of a vessel.

4. The valve of claim 3, wherein the body comprises a fluid pathway to allow a fluid to cross a vessel wall via the valve.

5. The valve of claim 1, wherein the valve further comprises at least one gate.

6. The valve of claim 5, wherein the gate is arranged to move within the fluid pathway between an open position and a closed position.

7. The valve of claim 6, wherein the movement of the gate changes the position of the magnet relative to the switch.

8. The valve of claim 1, further comprising a fluid permeable membrane.

9. The valve of claim 1, wherein the valve further comprises biasing means to urge the valve into either an open position or a closed position.

10. The valve of claim 9, wherein the biasing means urges the at least one gate into either an open position or a closed position.

11. The valve of claim 1, when comprising a gate, wherein the magnet is configured to at least one of assist movement of the gate or at least temporarily maintain a position of the gate.

12. The valve of claim 1, wherein the electric switch is arranged to be clippably connected to the valve.

13. The valve of claim 1, wherein the valve comprises a housing arranged to receive the electric switch.

14. The valve of claim 13, wherein the housing comprises a door.

15. The valve of claim 14, wherein the door is a hinged door
